(19) United States
(12) Patent Application Publication
(10) Pub. No.: US 2025/0300161 A1
(43) Pub. Date: Sep. 25, 2025

(54) PRESS FOR PERFORMING A CALENDERING TO ELECTRODE PLATE, ELECTRODE PLATE MANUFACTURING SYSTEM HAVING THE SAME, AND METHOD OF MANUFACTURING ELECTRODE PLATE USING THE SAME

(71) Applicant: SAMSUNG SDI CO., LTD., Yongin-Si (KR)

(72) Inventor: Hyunwoo KIM, Yongin-Si (KR)

(21) Appl. No.: 18/792,773

(22) Filed: Aug. 2, 2024

(30) Foreign Application Priority Data
Mar. 22, 2024 (KR) 10-2024-0039885
Apr. 24, 2024 (KR) 10-2024-0055041

(51) Int. Cl. H01M 4/04

(52) U.S. Cl. CPC H01M 4/0435; H01M 4/0404

(57) ABSTRACT

A press for performing a calendering to an electrode plate, including: a main roll above and below the electrode plate configured to move along a first direction, the main roll to be rotated by a driving force, and having a width along a second direction perpendicular to the first direction; a pulley part on at least one of above or below the electrode plate, and spaced from the main roll along the first direction; a pressure belt rotatably connected to the main roll and the pulley part, and to rotate about the second direction by the driving force and press the electrode plate at a contact angle to extrude the electrode plate along the first direction; and a contact controller to control at least one of a contact area or the contact angle between the electrode plate and the pressure belt by controlling a position of the pulley part.

### CROSS-REFERENCE TO RELATED APPLICATION

The present application claims priority to and the benefit of Korean Patent Application No. 10-2024-0039885, filed on Mar. 22, 2024, and Korean Patent Application No. 10-2024-0055041, filed on Apr. 24, 2024, in the Korean Intellectual Property Office, the entire disclosures of all of which are incorporated by reference herein.

### BACKGROUND

### 1. Field

Aspects of embodiments of the present disclosure relate to a press for performing a calendering to an electrode plate using a belt, a manufacturing system including the press, and a method for manufacturing the electrode plate using the manufacturing system.

### 2. Description of the Related Art

Generally, a secondary battery includes an electrode assembly including a positive electrode plate, a negative electrode plate, and a separator, a receiving can that accommodates the electrode assembly, and a cap assembly that is coupled with the receiving can to seal the electrode assembly. The cap assembly has electrode terminals that are electrically connected to the outside.

The electrode assembly is produced through an assembly process in which a positive electrode plate or a negative electrode plate (hereinafter referred to as an electrode plate) is manufactured by coating a certain thickness of a slurry of positive electrode active material or a negative electrode active material onto a positive electrode substrate or a negative electrode substrate (hereinafter referred to as a substrate). The positive and negative electrode plates are pressed onto a separator to ensure separation therebetween. The assembled electrode assembly may be accommodated in the receiving can in the form of a jelly roll shape or a stacked shape composed of multiple layers.

Once the coating of the active material slurry on the substrate is completed, a rolling (e.g., a calendering or a roll-pressing) process is generally performed on the electrode plate to increase the adhesion between the substrate and the active material, and to improve an electrode density.

The above information disclosed in this Background section is for enhancement of understanding of the background of the present disclosure, and therefore, it may contain information that does not constitute related (or prior) art.

### SUMMARY

Generally, in an electrode plate rolling process, the electrode plate is compressed to reduce its thickness and achieve a desired mixture density by passing the electrode plate between two rolls that are heated to a high temperature.

In this case, in order to maintain a uniform mixture density throughout the electrode plate, it may be desirable to maximize or increase a contact area between the electrode plate and the rolls. However, expanding the contact area between the rolls and the electrode plate may lead to an increased size and an increased load of the rolls, which may result in higher electrode rolling costs and time.

The use of oversized rolls in the electrode plate rolling process may not only increase the costs and the difficulty of roll replacement, but may also cause excessive damage to the electrode plate due to an axial twisting during the rolling process.

Further, when performing a pin rolling process to form a groove pattern for high-speed charging on an upper surface of an active material layer, by increasing the size of the roll on which the pins are arranged, the contact angle between the active material layer and the pins may be increased. The increase in the contact angle may result in a fracture (e.g., a cracking) in the active material layer during a process of inserting the pins into the active material layer and then removing the pins from the active material layer.

Therefore, an apparatus for rolling the electrode plate that can adjust the contact area of the electrode plate as needed or desired without increasing the size of the rolls, and a method for manufacturing the electrode plate using the apparatus, may be desired.

One or more embodiments of the present disclosure may be directed to a press for performing a calendering to an electrode plate for pressurizing the electrode plate by a belt, and for adjusting a contact area between the electrode plate and the belt.

One or more embodiments of the present disclosure may be directed to a system for manufacturing an electrode plate including the press.

One or more embodiments of the present disclosure may be directed to a method of manufacturing an electrode plate by the system.

These and other aspects and features of the present disclosure will be described in or will be apparent from the following description of embodiments of the present disclosure.

According to one or more embodiments of the present disclosure, a press for performing a calendering to an electrode plate, includes: a main roll above and below the electrode plate configured to move along a first direction, the main roll being configured to be rotated by a driving force, and having a width along a second direction perpendicular to the first direction; a pulley part on at least one of above or below the electrode plate, and spaced from the main roll along the first direction; a pressure belt rotatably connected to the main roll and the pulley part, and configured to rotate about the second direction by the driving force and press the electrode plate at a contact angle to extrude the electrode plate along the first direction; and a contact controller configured to control at least one of a contact area or the contact angle between the electrode plate and the pressure belt by controlling a position of the pulley part.

In an embodiment, the pulley part may include a pair of upper pulleys above the electrode plate, and horizontally spaced from a single upper main roll of the main roll located adjacent to an upper surface of the electrode plate. The pressure belt may include an upper pressure belt connected concurrently to the upper main roll and the pair of upper pulleys to form a closed upper circular loop that rotates by the driving force above the electrode plate, and configured to press the upper surface of the electrode plate.

In an embodiment, the pair of upper pulleys may include a first upper pulley and a second upper pulley spaced from left and right sides of the upper main roll, respectively, by equal distances as each other along the first direction.

In an embodiment, the press may further include an upper position control rod coupled to each of the first upper pulley and the second upper pulley, and configured to determine a position of each of the first upper pulley and the second upper pulley along the first direction and a third direction to change a shape of the upper pressure belt and adjust the contact area between the upper pressure belt and the electrode plate. The third direction may be perpendicular to the first direction and the second direction.

In an embodiment, the pulley part may further include a pair of lower pulleys below the electrode plate, and horizontally spaced from a single lower main roll of the main roll located adjacent to a lower surface of the electrode plate. The pressure belt may further include a lower pressure belt connected concurrently to the lower main roll and the pair of lower pulleys to form a closed lower circular loop that rotates by the driving force below the electrode plate, and configured to press the lower surface of the electrode plate.

In an embodiment, the pair of lower pulleys may include a first lower pulley and a second lower pulley spaced from left and right sides of the lower main roll, respectively, by equal distances as each other along the first direction.

In an embodiment, the press may further include a lower position control rod connected to each of the first lower pulley and the second lower pulley, and configured to control a position of each of the first lower pulley and the second lower pulley along the first direction and the third direction to change a shape of the lower belt and adjust the contact area between the lower belt and the electrode plate.

In an embodiment, the upper position control rod may include an upper rack gear, each of the first upper pulley and the second upper pulley may include an upper pinion gear configured to engage with the upper rack gear, an upper vertical position of each of the first upper pulley and the second upper pulley along the third direction may be determined by moving the upper pinion gear along the third direction, the lower position control rod may include a lower rack gear, each of the first lower pulley and the second lower pulley may include a lower pinion gear configured to engage with the lower rack gear, and a lower vertical position of each of the first lower pulley and the second lower pulley along the third direction may be determined by moving the lower pinion gear along the third direction.

In an embodiment, the press may further include a horizontal driver connected to at least one of the position control rod or the pulley part, and configured to adjust a separation distance between the pulley part and the main roll along the first direction to control a horizontal position of the pulley part along the first direction.

In an embodiment, the press may further include an upper tension detector connected to one of the pair of upper pulleys and the upper position control rod to detect a tension of the upper pressure belt; and a lower tension detector connected to one of the pair of lower pulleys and the lower position control rod to detect a tension of the lower pressure belt.

In an embodiment, each of the upper tension detector and the lower tension detector may include an elastic body.

In an embodiment, the press may further include: at least one upper tensioning pulley adjacent to an upper portion of the upper main roll, and configured to adjust an upper tension applied to the upper pressure belt by further tensioning the upper pressure belt upwardly along the third direction; and at least one lower tensioning pulley adjacent to a lower portion of the lower main roll, and configured to adjust a lower tension applied to the lower pressure belt by further tensioning the lower pressure belt downwardly along the third direction.

In an embodiment, the press may further include: an upper tension control rod connected with the upper tensioning pulley, and configured to control a position of the upper tensioning pulley along the third direction; and a lower tension control rod connected with the lower tensioning pulley, and configured to control a position of the lower tensioning pulley along the third direction.

In an embodiment, the contact controller may include: a horizontal controller configured to control a horizontal position of the pulley part along the first direction; a vertical controller configured to control a vertical position of the pulley part along a third direction perpendicular to the first direction and the second direction; and a tension controller configured to control a tension applied to the pressure belt.

In an embodiment, the contact controller may further include: a reference setting controller configured to provide reference data including the horizontal position, the vertical position, and the tension based on properties of the pressure belt and characteristics of the electrode plate; and a control processor configured to control the pulley part to move to the horizontal position and the vertical position within a reference tension range.

In an embodiment, the pressure belt may include a plurality of protruding pins on an outer surface of the pressure belt, the protruding pins being configured to contact the electrode plate to form a groove pattern on a surface of the electrode plate.

In an embodiment, the contact angle may be in a range from 5° to 20°, and the plurality of protruding pins may protrude from a surface of the pressure belt to a height ranging from 5 μm to 50 μm.

According to one or more embodiments of the present disclosure, a system for manufacturing an electrode plate, includes: a mixer configured to mix an active material, a binder, and a conductive agent with a solvent to form an active material slurry; a coater configured to coat the active material slurry on a substrate in a pattern to form the electrode plate having a coated portion where the active material slurry is coated and an uncoated portion where the active material slurry is not coated; and a press configured to compress the electrode plate to a thickness by contacting the electrode plate with a pressure belt configured to rotate at a contact angle and located on at least one of above or below the electrode plate.

In an embodiment, the press may include: a main roll above and below the electrode plate configured to move along a first direction, the main roll being configured to rotate by a driving force, and having a width along a second direction perpendicular to the first direction; a pulley part on at least one of above or below the electrode plate, and spaced from the main roll along the first direction; and a contact controller configured to control at least one of a contact area or the contact angle between the electrode plate and the pressure belt by controlling a position of the pulley part.

According to one or more embodiments of the present disclosure, a method of manufacturing an electrode plate, includes: connecting a pressure belt to one of a pair of main rolls arranged to positionally correspond to each other in a vertical direction and to a pair of pulleys disposed along a first direction to be spaced apart from at least one of the pair of main rolls by an equal distance; adjusting positions of the pair of pulleys along the first direction and a third direction perpendicular to the first direction and passes through the pair of main rolls; rotating the pressure belt by driving the pair of main rolls to rotate in opposite directions from each other; and inserting the electrode plate along the first direction between the pair of rotating main rolls, and extruding the electrode plate by pressing the electrode plate using the pressure belt or by pressing the electrode plate while forming grooves on a surface of the electrode plate using the pressure belt.

According to some embodiments of the present disclosure, the electrode plate may be extruded not by a main roll, but by a pressure belt rotated and pressurized by the main roll.

According to some embodiments of the present disclosure, by arranging protruding pins on the surface of the pressure belt instead of the main roll, a groove pattern may be formed on the surface of the electrode plate without causing a fracture in the active material layer.

According to some embodiments of the present disclosure, desired horizontal and vertical positions (e.g., optimal horizontal and vertical positions) of a pulley part and/or a tensioning pulley may be automatically determined (e.g., may be automatically set or configured) based on the properties of the electrode plate to be rolled, the characteristics of the pressure belt in contact with the electrode plate, and the kind of the rolling process.

According to some embodiments of the present disclosure, the contact area between the electrode plate and the pressure belt may be increased or maximized, and the contact angle between the electrode plate and the pressure belt may be reduced, without increasing the size of the main roll, and thus, the uniformity of the rolling process on the electrode plate may be increased and fracture defects in the active material layer may be prevented or reduced.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a diagram illustrating a press for performing a calendering to an electrode plate according to an embodiment of the present disclosure;

FIGS. 2A and 2B are cross-sectional views illustrating the electrode plate shown in FIG. 1;

FIG. 3 is a diagram illustrating an example of a double-sided calendering structure of the press shown in FIG. 1;

FIG. 4 is a diagram illustrating an example of a single-sided calendering structure of the press shown in FIG. 1;

FIG. 5 is a diagram illustrating a calendering structure equipped with a position control rod according to an embodiment of the present disclosure;

FIG. 6 is a diagram illustrating the position control rod shown in FIG. 5 according to an embodiment of the present disclosure;

FIG. 7 is a diagram illustrating a calendering structure including a horizontal driver according to an embodiment of the present disclosure;

FIG. 8 is a diagram illustrating a calendering structure including a tensioning pulley according to an embodiment of the present disclosure;

FIG. 9 is a diagram illustrating a calendering structure equipped with an additional tension detector according to an embodiment of the present disclosure;

FIG. 10 is a diagram illustrating a calendering structure equipped with protruding pins according to an embodiment of the present disclosure;

FIG. 11 is a plan view illustrating the protruding pins shown in FIG. 10 arranged on the pressure belt;

FIG. 12 is a diagram illustrating an electrode plate having a groove pattern formed by the calendering structure shown in FIG. 10;

FIG. 13 is a diagram illustrating a contact controller of the electrode plate calendering press shown in FIG. 1;

FIG. 14 is a diagram illustrating an electrode plate manufacturing system including the electrode plate calendering press shown in FIG. 1; and

FIG. 15 is a flowchart illustrating a method for performing a calendering to an electrode plate using the press shown in FIG. 1.

### DETAILED DESCRIPTIONS

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, ”at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein.

Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components ”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

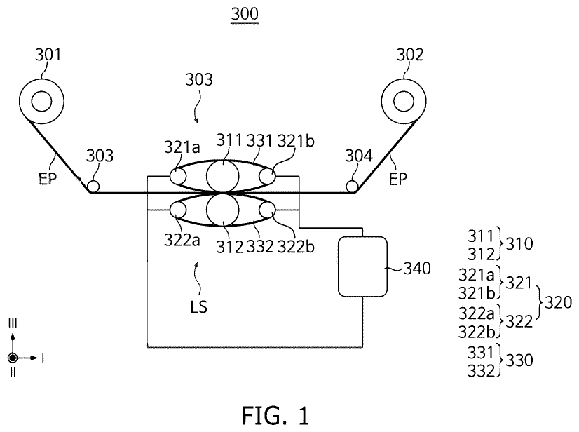

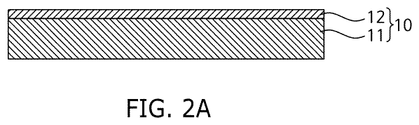

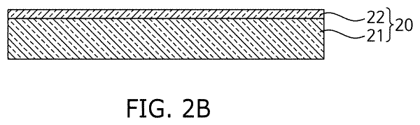

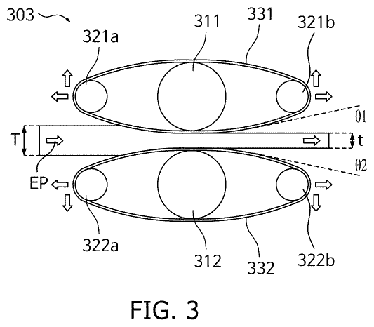

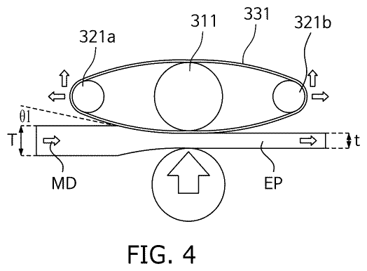

FIG. 1 is a diagram illustrating a press for performing a calendering to an electrode plate according to an embodiment of the present disclosure. FIGS. 2A and 2B are cross-sectional views illustrating the electrode plate shown in FIG. 1. FIG. 3 is a diagram illustrating an example of a double-sided calendering structure of the press shown in FIG. 1. FIG. 4 is a diagram illustrating an example of a single-sided calendering structure of the press shown in FIG. 1.

Referring to FIGS. 1 to 4, a press 300 (hereinafter, referred to as an electrode plate calendering press) for performing a calendering to an electrode plate according to an embodiment of the present disclosure may include a main roll 310, a pulley part 320, a pressure belt 330 rotatably connected to (e.g., rotatably coupled or attached to) the main roll 310 and the pulley part 320 to pressurize an electrode plate EP to be rolled, and a contact controller 340 that controls a position of the pulley part 320 to adjust a contact angle 0 and a contact area between the electrode plate EP and the pressure belt 330.

In an embodiment, the main roll 310 is disposed above and below (e.g., under) the electrode plate EP that moves along a first direction I and has a width along a second direction II perpendicular to or substantially perpendicular to the first direction I. The main roll 310 may be rotated by a driving force to perform a rolling operation on the electrode plate EP.

The electrode plate EP may be formed by coating an active material slurry on a current collector, and may serve as a mother substrate for manufacturing electrodes of a battery. Accordingly, the active material slurry, which is a mixture including polar materials, may be coated on the substrate to form the electrode plate EP, and the electrode plate EP is then pressed through the electrode plate calendering press 300 to enhance an adhesion between the substrate and the active material slurry, thereby improving an electrode density.

The electrode plate EP may include a positive electrode plate 10 or a negative electrode plate 20 depending on a desired polarity. FIG. 2A is a cross-sectional view of the positive electrode plate 10, and FIG. 2B is a cross-sectional view of the negative electrode plate 20.

As shown in FIG. 2A, the positive electrode plate 10 may include a positive electrode substrate 11, which is a current collector, and a positive electrode active material layer 12 coated on a portion of the positive electrode substrate 11.

For example, the positive electrode substrate 11 may include a positive current collector having aluminum (Al). A mixture including positive electrode active material mixed with a binder and/or a conductive material may be coated on the positive electrode substrate 11 as the positive electrode active material layer 12.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

As shown in FIG. 2B, the negative electrode plate 20 may include a negative electrode substrate 21, which is a current collector, and a negative electrode active material layer 22 coated on a portion of the negative electrode substrate 21.

For example, the negative current collector may include a copper foil, a nickel foil, a stainless-steel foil, a titanium foil, a nickel foam, a copper foam, a polymer substrate coated with a conductive metal, or a combination thereof. A mixture including negative electrode active material mixed with a binder and/or a conductive material may be coated on the negative electrode substrate 21 as the negative electrode active material layer 22.

For example, the negative electrode active material layer 22 may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a(meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

In the present embodiment, the positive electrode plate 10 may be formed by applying a positive electrode active material, such as a transition metal oxide, onto a substrate formed of a metal foil, such as aluminum or an aluminum alloy. The positive electrode plate 10 may further include a positive uncoated portion where the positive electrode active material is not applied. The negative electrode plate 20 may be formed by applying an active material, such as graphite or carbon, onto a substrate formed of a metal foil, such as copper, a copper alloy, nickel, or a nickel alloy. The negative electrode plate 20 may further include a negative uncoated portion where the active material is not applied.

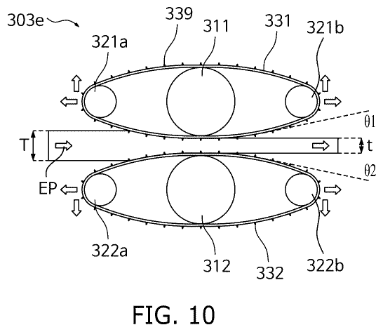

The electrode plate EP may have a length along the first direction I, and a width along the second direction II perpendicular to or substantially perpendicular to the first direction I. The electrode plate EP may be unwound from a coater for the active material slurry (e.g., a coater 200 shown in FIG. 10), and inserted between an upper main roll 311 and a lower main roll 312 of the main roll 310.

Accordingly, the electrode plate EP may be compressed by a pressing force applied to the main roll 310, and may move along the first direction I. In other words, the electrode plate EP may be extruded along the first direction I while passing between the upper main roll 311 and the lower main roll 312 of the main roll 310, so that an initial thickness T before passing the main roll 310 may be reduced to a rolled thickness t.

For example, the main roll 310 may include the upper main roll 311 disposed above the electrode plate EP, and the lower main roll 312 disposed below (e.g., underneath) the electrode plate EP. The upper main roll 311 and the lower main roll 312 may be aligned with each other in a line along a third direction III perpendicular to or substantially perpendicular to the first direction I and the second direction II.

Each of the upper main roll 311 and the lower main roll 312 may be rotatably connected to (e.g., rotatably fixed to) a corresponding rotation axis. The upper main roll 311 and the lower main roll 312 may rotate in opposite directions from each other. The rotation axis may be driven by a separate main driver that rotates the main rolls 310, and moves linearly along the third direction III.

In more detail, the upper main roll 311 and the lower main roll 312 may be arranged to be suitably close to each other by the main driver, so as to have a gap therebetween corresponding to the rolled thickness t.

In an embodiment, the pulley part 320 may be positioned at least one of either above or below (e.g., underneath) the electrode plate EP, so as to be spaced apart from the main roll 310 along the first direction I. The pulley part 320 may be combined with the main roll 310 and the pressure belt 330 to configure the pressure belt 330 in a closed circular loop.

In other words, the main roll 310 and the pulley part 320 may serve as a rotation support structure around which the rotating pressure belt 330 is wound. The pressure belt 330 may be installed to concurrently or substantially simultaneously contact outer circumferential surfaces of both of the main roll 310 and the pulley part 320 with a constant or substantially constant tension. Consequently, the pressure belt 330 may rotate along with the main roll 310 due to a sufficient frictional force adhering the pressure belt 330 to the outer circumferential surfaces of both of the main roll 310 and the pulley part 320.

In this case, the pulley part 320 may be provided as a directional change member to alter a direction of the rotation of the pressure belt 330. Accordingly, the rotating pressure belt 330 may be brought into contact with the circumferential surface of the pulley part 320, and the pulley part 320 may rotate as the pressure belt 330 moves. Thus, the pulley part 320 is configured to rotate based on the linear speed of the pressure belt 330, without using a separate driving member.

Because the pulley part 320 may be provided as a member for the rotation of the pressure belt 330, the pulley part 320 may be disposed on at least one of above or below (e.g., underneath) the electrode plate EP depending on the position of the pressure belt 330.

As shown in FIG. 3, a calendering structure 303 may be provided as a double-sided structure where the pulley part 320 and the pressure belt 330 are disposed above and below (e.g., underneath) the electrode plate EP, or as shown in FIG. 4, the calendering structure 303 may be provided as a single-sided structure where the pulley part 320 and the pressure belt 330 are disposed only above or only below the electrode plate EP.

For example, in a case where only an upper portion of the electrode plate EP is coated with an active material, the pressure belt 330 may be disposed only above the electrode plate EP, while no pressure belt 330 is disposed below the electrode plate EP. Thus, in the case of the single-sided calendering structure, the pressure belt 330 may be selectively disposed either above or below the electrode plate EP.

The pulley part 320 may include a pair of upper pulleys 321 and a pair of lower pulleys 322. The upper pulleys 321 may be positioned above the electrode plate EP, and may be spaced apart from the upper main roll 311 along the first direction I. The lower pulleys 322 may be positioned below (e.g., underneath) the electrode plate EP, and may be spaced apart from the lower main roll 312 along the first direction I.

In the present embodiment, the upper pulleys 321 may include a first upper pulley 321a and a second upper pulley 321b that are spaced apart from the upper main roll 311 by an equal or substantially equal distance as each other to the left and right, respectively, along the first direction. The lower pulleys 322 may include a first lower pulley 322a and a second lower pulley 322b that are spaced apart from the lower main roll 312 by an equal or substantially equal distance as each other to the left and right, respectively, along the first direction I.

In more detail, the first upper pulley 321a and the second upper pulley 321b may have a size smaller than that of the upper main roll 311, allowing an upper belt 331, which is the pressure belt 330 positioned above the electrode plate EP, to have an elliptical shape with a greatest width in a region where the upper belt 331 is in contact with the upper main roll 311. As a result, the electrode plate EP may be pressed by the upper belt 331.

Similarly, the first lower pulley 322a and the second lower pulley 322b may have a size smaller than that of the lower main roll 312, allowing a lower belt 332, which is the pressure belt 330 positioned below (e.g., underneath) the electrode plate EP, to have an elliptical shape with a greatest width in a region where the lower belt 332 is in contact with the lower main roll 312. As a result, the electrode plate EP may be pressed by the lower belt 332.

The upper belt 331 may form an upper circular loop having a closed elliptical shape that is rotated by a driving force above the electrode plate EP and is pressed by the driving force of the upper main roll 311, such that the upper belt 331 contacts and presses the upper surface of the electrode plate EP at an upper contact angle θ1.

Further, the lower belt 332 may form a lower circular loop having a closed elliptical shape that is rotated by a driving force below (e.g., underneath) the electrode plate EP and is pressed by the driving force of the lower main roll 312, such that the lower belt 332 contacts and presses the lower surface of the electrode plate EP at a lower contact angle θ2.

Accordingly, the electrode plate EP may be extruded along the first direction I, while being compressed at a contact angle determined by (e.g., set by or configured by) the pressure belt 330 from above and/or below (e.g., underneath) the electrode plate EP.

In this case, the pulley part 320 may be disposed at appropriate positions along the first direction I and the third direction III, to adjust the contact area or the contact angle between the pressure belt 330 and the electrode plate EP, or to adjust the tension applied to the pressure belt 330.

In other words, by adjusting the position of the pulley part 320 along the first direction I and the third direction III, the tension applied to the pressure belt 330 and the contact area or the contact angle between the pressure belt 330 and the electrode plate EP may be appropriately adjusted.

In an embodiment, each of the first upper pulley 321a, the second upper pulley 321b, the first lower pulley 322a, and the second lower pulley 322b may include a position control rod 350 to control the position of the corresponding pulley individually.

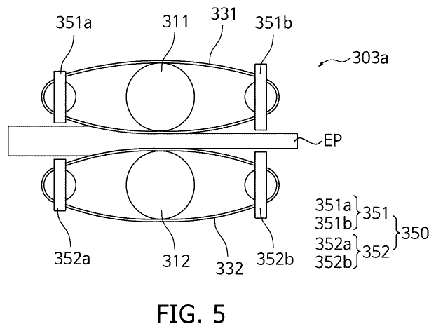

FIG. 5 is a diagram illustrating a calendering structure equipped with a position control rod according to an embodiment of the present disclosure.

In FIG. 5, the calendering structure 303a may have the same or substantially the same configuration as that of the calendering structure 303 described above with reference to FIG. 3, except that a position control rod 350 is disposed on each of the first upper pulley 321a, the second upper pulley 321b, the first lower pulley 322a, and the second lower pulley 322b. Accordingly, in FIG. 5, like reference numerals are used to denote like (e.g., the same or substantially the same) parts as those described above with reference to FIG. 3, and redundant description thereof may not be repeated.

Referring to FIG. 5, the calendering structure 303a may further include the position control rod 350 including upper position control rods 351 that control the positions of the upper pulleys 321, and lower position control rods 352 that control the positions of the lower pulleys 322.

The upper position control rods 351 may include a first upper rod 351a for controlling (e.g., for configuring or setting) the position of the first upper pulley 321a along the first direction I and the third direction III, and a second upper rod 351b for controlling (e.g., for configuring or setting) the position of the second upper pulley 321b along the first direction I and the third direction III.

By controlling the positions of the first upper pulley 321a and the second upper pulley 321b by the first upper rod 351a and the second upper rod 351b, the shape of the upper belt 331 and the tension applied to the upper belt 331 may be controlled or adjusted. As such, the contact area between the upper belt 331 and the upper surface of the electrode plate EP may be adjusted.

The lower position control rods 352 may include a first lower rod 352a for controlling (e.g., for configuring or setting) the position of the first lower pulley 322a along the first direction I and the third direction III, and a second lower rod 352b for controlling (e.g., for configuring or setting) the position of the second lower pulley 322b along the first direction I and the third direction III.

By controlling the positions of the first lower pulley 321a and the second lower pulley 321b by the first lower rod 352a and the second lower rod 352b, the shape of the lower belt 332 and the tension applied to the lower belt 332 may be controlled or adjusted. As such, the contact area between the lower belt 332 and the lower surface of the electrode plate EP may be adjusted.

In the present embodiment, each position control rod 350 may be configured as a combination of a rack and a pinion.

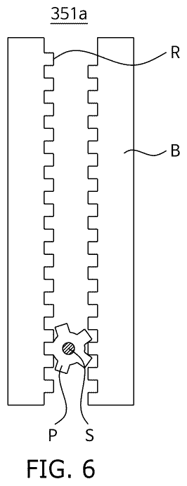

FIG. 6 is a diagram illustrating the position control rod shown in FIG. 5 according to an embodiment of the present disclosure.

While FIG. 6 illustrates the first upper rod 351a as a representative example, the second upper rod 351b, the first lower rod 352a, and the second lower rod 352b may have the same or substantially the same configuration as that of the first upper rod 351a.

Referring to FIG. 6, the first upper rod 351a may have rack gears R disposed on opposing inner surfaces of a rod body B having a cylindrical shape, and a pinion (e.g., a pinion gear) P arranged inside the rod body B for engagement with the rack gears R.

Accordingly, a rotation axis S of the first upper pulley 321a, extending in the width direction of the electrode plate EP corresponding to the second direction II, may be connected to (e.g., coupled to) the pinion P. Thus, when the pinion P moves along the third direction Ill in engagement with the rack gears R, the first upper pulley 321a connected to the pinion P may also move along the third direction III in the same manner.

In other words, upper vertical positions, which are the vertical positions of the first upper pulley 321a and the second upper pulley 321b in the third direction III, may be adjusted by the movement of the pinion P along the rack gears R. Similarly, lower vertical positions, which are the vertical positions of the first lower pulley 322a and the second lower pulley 322b in the third direction III, may be adjusted by the movement of the pinion P along the rack gears R.

A horizontal position of the pulley part 320 in the first direction I may be adjusted by a horizontal driver 360.

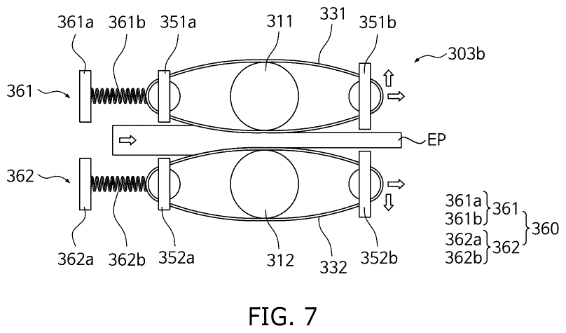

FIG. 7 is a diagram illustrating a calendering structure including a horizontal driver according to an embodiment of the present disclosure.

In FIG. 7, the calendering structure 303b may have the same or substantially the same configuration as that of the calendering structure 303a described above with reference to FIG. 5, except that the calendering structure 303b of FIG. 7 may further include the horizontal driver 360 provided to adjust the horizontal position of the pulley part 320. Accordingly, in FIG. 7, like reference numerals are used to denote like parts (e.g., the same or substantially the same parts) as those described above with reference to FIG. 5, and redundant description thereof may not be repeated.

Referring to FIG. 7, the calendering structure 303b may further include the horizontal driver 360 that is connected to at least one of the position control rod 350 or the pulley part 320 to adjust a separation distance between the pulley part 320 and the main roll 310 along the first direction I. Accordingly, the horizontal position, which is a position of the pulley part 320 along the first direction I, may be controlled or adjusted by the horizontal driver 360.

For example, the horizontal driver 360 may include an upper horizontal driver 361 and a lower horizontal driver 362. The upper horizontal driver 361 may be connected to the upper position control rod 351 and/or the upper pulley 321 to adjust a separation distance between the upper pulley 321 and the upper main roll 311 along the first direction I. The lower horizontal driver 362 may be connected to the lower position control rod 352 and/or the lower pulley 322 to adjust a separation distance between the lower pulley 322 and the lower main roll 311 along the first direction I.

The tension applied to the pressure belt 330 may vary depending on the separation distance between the pulley part 320 and the main roll 310, and the contact angle between the electrode plate EP and the pressure belt 330 may vary depending on the tension applied to the pressure belt 330. Therefore, the contact area between the pressure belt 330 and the electrode plate EP may be adjusted according to the horizontal position of the pulley part 320.

In the present embodiment, a first upper horizontal driver 361a and a first lower horizontal driver 362a are illustrated as representative examples of some components that are capable of horizontally moving the first upper rod 351a and the first lower rod 352a, respectively. However, the present disclosure is not limited thereto.

For example, in some embodiments, a second upper horizontal driver and a second lower horizontal driver may be further arranged to horizontally move the second upper rod 351b and the second lower second 352b, respectively. The second upper horizontal driver and the second lower horizontal driver may have the same or substantially the same configurations as those of the first upper horizontal driver 361a and the first lower horizontal driver 362a, respectively.

As will be described in more detail below, the horizontal driver 360 may be controlled by the contact controller 340, thereby adjusting the horizontal position of the pulley part 320 to achieve an appropriate contact area based on the characteristics of the electrode plate EP and the characteristics of the pressure belt 330.

The horizontal driver 360 may include a tension detector.

If the pulley part 320 moves excessively horizontally, the pressure belt 330 may be cut, and the function of the electrode plate calendering press 300 may be stopped. Therefore, by detecting a horizontal movement distance during the horizontal movement of the pulley part 320, the separation distance between the pulley part 320 and the main roll 310 may be limited within a desired range (e.g., a set or predetermined range).

For example, the tension detector may include an upper tension detector and a lower tension detector. The upper tension detector may be connected to one of the pair of upper pulleys 321 and the upper position control rod 351 to detect the tension of the upper belt 331. Similarly, the lower tension detector may be connected to one of the pair of lower pulleys 322 and the lower position control rod 352 to detect the tension of the lower belt 332.

Because the tension applied to the pressure belt 330 is uniformly or substantially uniformly distributed along the pressure belt 330, the tension may be detected by measuring the movement distance of either the upper pulley 321 or the lower pulley 322.

For example, the upper tension detector may include an upper elastic body 361b disposed between the upper horizontal driver 361 and the upper pulley 321, and the lower tension detector may include a lower elastic body 362b disposed between the lower horizontal driver 362 and the lower pulley 322.

The tension of the pulley part 320 may be adjusted through the control of the horizontal and vertical positions of the pulley part 320, but may also be adjusted by a separate tensioning pulley.

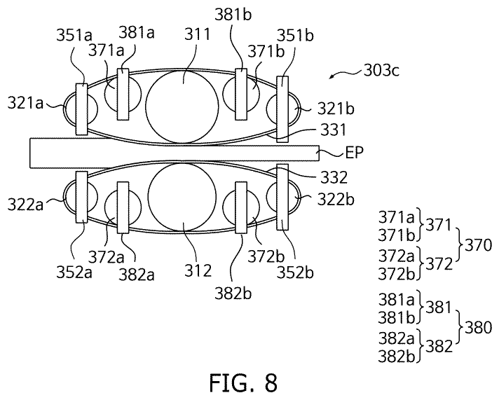

FIG. 8 is a diagram illustrating a calendering structure including a tensioning pulley according to an embodiment of the present disclosure.

In FIG. 8, the calendering structure 303c may have the same or substantially the same configuration as that of the calendering structure 303a described above with reference to FIG. 5, except that the calendering structure 303c may further include a tensioning pulley 370. Accordingly, in FIG. 8, like reference numerals are used to denote like parts (e.g., the same or substantially the same parts) as those described above with reference to FIG. 5, and redundant description thereof may not be repeated.

Referring to FIG. 8, the calendering structure 303c according to an embodiment of the present disclosure may further include the tensioning pulley 370 provided to adjust the tension of the pressure belt 330. The tensioning pulley 370 may be provided to apply an additional tension to each of the upper belt 331 and the lower belt 332 disposed with the upper main roll 311 and lower main roll 312, respectively, to adjust the tension of the pressure belt 330.

For example, the tensioning pulley 370 may include at least one upper tensioning pulley 371 and at least one lower tensioning pulley 372. The upper tensioning pulley 371 may be disposed adjacent to the upper portion of the upper main roll 311 to apply the additional upward tension to the upper belt 331 along the third direction III, thereby adjusting the upper tension applied to the upper belt 331. Similarly, the lower tensioning pulley 372 may be disposed adjacent to the lower portion of the lower main roll 312 to apply the additional downward tension to the lower belt 332 along the third direction III, thereby adjusting the lower tension applied to the lower belt 332.

Accordingly, the pressure belt 330 may rotate in an elliptical shape while contacting the outer circumferential surfaces of the main roll 310, the pulley part 320, and the tensioning pulley 370. By adjusting the upward and downward movement of the tensioning pulley 370, the amount of additional tensioning force applied to the pressure belt 330 may be determined.

In the present embodiment, the upper tensioning pulley 371 may include a pair of a first upper adjustment pulley 371a and a second upper adjustment pulley 371b that are symmetrically arranged with respect to the upper portion of the upper main roll 311. The lower tensioning pulley 372 may include a pair of a first lower adjustment pulley 372a and a second lower adjustment pulley 372b that are symmetrically arranged with respect to the lower portion of the lower main roll 312.

However, the present disclosure is not limited thereto, and the number of the upper tensioning pulleys 371 and the lower tensioning pulleys 372 may be variously modified depending on the desired tension adjustment.

The movement of the tensioning pulley 370 along the third direction III may be carried out by a tension control rod 380. The tension control rod 380 may be individually connected to (e.g., individually coupled or attached to) the tensioning pulley 370 to enable the tensioning pulley 370 to move along the third direction III.

For example, the tension control rod 380 may include an upper tension control rod 381 and a lower tension control rod 382. The upper tension control rod 381 may be connected with (e.g., coupled with or attached with) the upper tensioning pulley 371 to control the position of the upper tensioning pulley 371 along the third direction III. The lower tension control rod 382 may be connected with (e.g., coupled with or attached with) the lower tensioning pulley 372 to control the position of the lower tensioning pulley 372 along the third direction III.

In the present embodiment, the upper tension control rod 381 may include a first upper tension control rod 381a and a second upper tension control rod 381b connected with (e.g., coupled with or attached with) the pair of the first upper adjustment pulley 371a and the second upper adjustment pulley 371b. Further, the lower tension control rod 382 may include a first lower tension control rod 382a and a second lower tension control rod 382b connected with (e.g., coupled with or attached with) the pair of the first lower adjustment pulley 372a and the second lower adjustment pulley 372b.

For example, the tension control rod 380 may have the same or substantially the same configuration as that of the position control rod 350 described above, and the tensioning pulley 370 may have the same or substantially the same configuration as that of the pulley part 320 described above. Accordingly, the coupling configuration of the tensioning pulley 370 and the tension control rod 380 may be the same or substantially the same as the coupling configuration of the pulley part 320 and the position control rod 350, and therefore, redundant description thereof may not be repeated.

An additional tension detector 390 may be further disposed at an upper portion of the tension control rod 380.

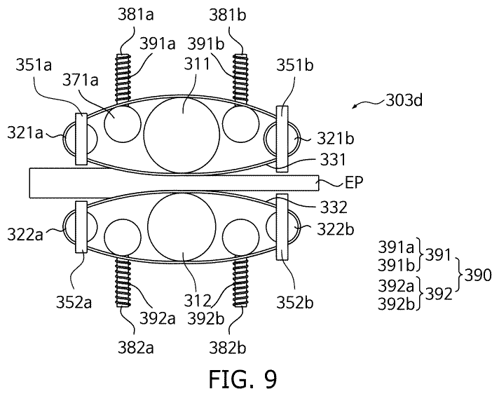

FIG. 9 is a diagram illustrating a calendering structure equipped with an additional tension detector according to an embodiment of the present disclosure.

In FIG. 9, the calendering structure 303d may have the same or substantially the same configuration as that of the calendering structure 303c described above with reference to FIG. 8, except that the calendering structure 303d in FIG. 9 may further include the additional tension detector 390. Accordingly, in FIG. 9, like reference numerals are used to denote like parts (e.g., the same or substantially the same parts) as those described above with reference to FIG. 8, and redundant description thereof may not be repeated.

If the tensioning pulley 370 moves excessively upward and downward during the vertical movement thereof, the pressure belt 330 may be cut, and the function of the electrode plate calendering press 300 may be stopped. Accordingly, in the process of the upward and downward movement of the tensioning pulley 370, the vertical movement distance may be detected by the additional tension detector 390 to limit the separation distance between the tensioning pulley 370 and the main roll 310 within a desired range (e.g., a preset or predetermined range).

Referring to FIG. 9, the calendering structure 303d according to an embodiment of the present disclosure may further include the additional tension detector 390.

The additional tension detector 390 may include an upper additional tension detector 391 and a lower additional tension detector 392. The upper additional tension detector 391 may be connected to the upper tensioning pulley 371 and the upper tension control rod 381 to detect the tension of the upper belt 331 wound on the outer circumferential surface of the upper tensioning pulley 371. Similarly, the lower additional tension detector 392 may be connected to the lower tensioning pulley 372 and the lower tension control rod 382 to detect the tension of the lower belt 332 wound on the outer circumferential surface of the lower tensioning pulley 372.

In the present embodiment, the additional tension detector 390 may be arranged for each tensioning pulley 370. Accordingly, the upper additional tension detector 391 may include a first upper additional tension detector 391a and a second upper additional tension detector 391b. The first upper additional tension detector 391a may be disposed between the first upper adjustment pulley 371a and the first upper tension control rod 381a. The second upper additional tension detector 391b may be disposed between the second upper adjustment pulley 371b and the second upper tension control rod 381b.

Further, the lower additional tension detector 392 may include a first lower additional tension detector 392a and a second lower additional tension detector 392b. The first lower additional tension detector 392a may be disposed between the first lower adjustment pulley 372a and the first lower tension control rod 382a. The second lower additional tension detector 392b may be disposed between the second lower adjustment pulley 372b and the second lower tension control rod 382b.

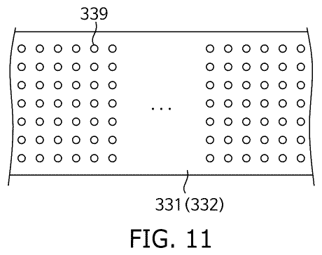

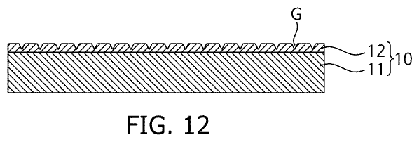

FIG. 10 is a diagram illustrating a calendering structure equipped with protruding pins according to an embodiment of the present disclosure. FIG. 11 is a plan view illustrating the protruding pins shown in FIG. 10 arranged on the pressure belt. FIG. 12 is a diagram illustrating an electrode plate having a groove pattern formed by the calendering structure shown in FIG. 10.

In FIGS. 10 and 11, the calendering structure 303e may have the same or substantially the same configuration as the calendering structure 303 described above with reference to FIG. 3, except that a plurality of protruding pins 339 may be arranged on an outer surface of the pressure belt 330. Accordingly, in FIGS. 10 and 11, like reference numerals are used to denote like parts (e.g., the same or substantially the same parts) as those described above with reference to FIG. 3, and redundant description thereof may not be repeated.

Referring to FIGS. 10 to 12, the calendering structure 303e according to an embodiment of the present disclosure may further include the plurality of protruding pins 339 for forming a groove pattern on a surface of the active material layer provided on the electrode plate EP.

The protruding pins 339 may be arranged at regular intervals on the outer surface of the pressure belt 330, and may rotate with the pressure belt 330 to form a plurality of grooves G on the surface of the electrode plate EP.

An inner surface of the pressure belt 330 may be in contact with the main roll 310 and the pulley part 320, and the outer surface of the pressure belt 330 may be configured to press and extrude the surface of the incoming electrode plate EP. In this case, the protruding pins 339 arranged on the outer surface of the electrode plate EP may move along the direction of rotation of the pressure belt 330 to form the grooves G on the surface of the electrode plate EP.

For example, as shown in FIG. 10, in the case of forming the grooves G on the positive electrode plate 10, the protruding pins 339 may be configured to be inserted into the active material layer 12 to form the grooves G, each having a desired depth (e.g., a set or predetermined depth) without damaging the underlying positive electrode substrate 11. The depth of each groove G may correspond to a height of each protruding pin 339.

In more detail, the protruding pins 339 may be arranged on the surface of the pressure belt 330 rather than on the main roll 310, so that damage to the active material layer 12 that may be caused by the protruding pins 339 may be minimized or reduced by adjusting the contact angle.

For example, if the upper contact angle θ1 between the upper belt 331 and the positive electrode plate 10 is large, the curvature radius of the trajectory of the protruding pins 339 becomes smaller. This can lead to a fracture in the positive electrode active material layer 12 when the protruding pins 339 are inserted into the positive electrode active material layer 12 to form the grooves G, and then removed from the positive electrode active material layer 12.

In the present embodiment, the contact angle of the pressure belt 330 may be adjusted to suppress the fracture of the positive electrode active material layer 12 by adjusting a distance between the first upper pulley 321a and the second upper pulley 321b, and adjusting a distance between the first lower pulley 322a and the second lower pulley 322b.

Therefore, when the positive electrode plate 10 is introduced between the upper main roll 311 and the lower main roll 312, a pin rolling process may be performed on the positive electrode plate 10 by rotating the pressure belt 330 having the protruding pins 339 thereon, after adjusting (e.g., setting or controlling) the upper contact angle θ1 between the upper belt 331 and the positive electrode plate 10 and the lower contact angle θ2 between the lower belt 332 and the positive electrode plate 10 to sufficiently small values.

Accordingly, as the positive electrode plate 10 is rolled by the pressure belt 330, the plurality of grooves G corresponding to the protruding pins 339 may be formed on the positive electrode active material layer 12. In other words, a groove pattern having the plurality of grooves G may be formed on the upper surface of the positive electrode plate 10.

The groove pattern formed on the upper surface of the positive electrode plate 10 may vary depending on the arrangement of the protruding pins 339 and the contact angle of the pressure belt 330. For example, the density of the groove pattern formed on the positive electrode active material layer 12 may be controlled by adjusting the contact angle within a suitable range that can prevent the fracture.

While the present embodiment describes the formation of the groove pattern on the positive electrode plate 10, the same or substantially the same pin rolling process may be used to form a groove pattern on the negative electrode plate 20.

The groove pattern formed on the surface of the electrode plate (EP) may create ion pathways deep into the active material layer, thereby increasing the charge and discharge rate of the secondary battery. Consequently, the performance of the secondary battery having the electrode plate EP may be improved.

In the present embodiment, the protruding pins 339 may protrude from the surface of the pressure belt 330 to have a height ranging from about 5 μm to about 50 μm. If the height of the protruding pins 339 is less than 5 μm, the depth of the groove G may be too small to effectively serve as the ion pathways. If the height of the protruding pins 339 exceeds 50 μm, the protruding pins 339 may penetrate the active material layer, causing damage to the substrate. Accordingly, it may be desirable for the protruding pins 339 to protrude from the surface of the pressure belt 330 to have a height ranging from about 5 μm to about 50 μm, or in more detail, with a range (e.g., an optimal range) of about 10 μm to about 40 μm.

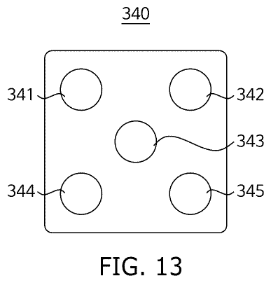

FIG. 13 is a diagram illustrating a contact controller of the electrode plate calendering press shown in FIG. 1.

Referring to FIG. 13, the contact controller 340 may include a horizontal controller 341, a vertical controller 342, a tension controller 343, a reference setting unit (e.g., a reference setting controller) 344, and a control processor 345.

The horizontal controller 341 may control a horizontal position, which is the position of the pulley part 320, along the first direction I. By detecting a current position of the pulley part 320 and comparing it with a target position included in reference data, the horizontal controller 341 may control the horizontal driver 360 to move the pulley part 320 to the target position.

The vertical controller 342 may control a vertical position, which is the position of the pulley part 320, along the third direction III. For example, the vertical controller 342 may control the position control rod 350 and the pulley part 320 and/or the tension control rod 380 and the tensioning pulley 370 to control the pulley part 320 and/or the tensioning pulley 370 to be positioned at a desired (e.g., a set or predetermined) vertical height.

If the tension of the pressure belt 330 obtained from the tension detector 367 and the additional tension detector 390 exceeds an allowable range, the tension controller 343 may control the horizontal driver 360 and the position control rod 350 together with the pulley part 320 or the tension control rod 380 to reset the horizontal position and the vertical position, so that the tension of the pressure belt 330 is within the allowable range.

The reference setting unit 344 may provide reference data for the horizontal position, the vertical position, and the tension based on the properties of the pressure belt 330 and the characteristics of the electrode plate EP. For example, existing usage data may be analyzed to determine desired (e.g., optimal) horizontal position, vertical position, and tension based on the properties of the pressure belt 330 and the characteristics of the electrode plate EP, and the determined data may be stored in a database. The reference setting unit 344 may then provide the desired (e.g., optimal) position and tension, for example, in a case where the pressure belt 330 and the electrode plate EP are replaced.

The control processor 345 may control the horizontal controller 341 and the vertical controller 342 to position the pulley part 320 to the desired (e.g., the optimal) horizontal position and vertical positions within an allowable tension range.

Accordingly, the position of the pulley part 320 may be automatically configured (e.g., may be automatically optimized) based on the characteristics of the pressure belt 330 and the electrode plate EP. As a result, the rolling process between the pressure belt 330 and the electrode plate EP may be carried out with a desired contact area and a desired contact angle (e.g., with an optimal contact area and an optimal contact angle).

In the present embodiment, in a case where the pressure belt 330 includes either stainless steel or stainless steel coated with a polymer, the contact angle between the electrode plate EP and the pressure belt 330 may be adjusted by controlling (e.g., by setting) the horizontal position and vertical position to fall within a range of about 5° to 20°.

If the contact angle of the pressure belt 330 is less than 5°, the contact area between the pressure belt 330 and the electrode plate EP may be significantly increased, making it more difficult to apply the desired pressure to the electrode plate for rolling. On the other hand, if the contact angle exceeds 20°, the contact area may become too small, causing the rolling process to be uneven and/or causing defects, such as fracture, during the pin rolling process. Accordingly, the contact angle of the pressure belt 330 may be in a range from about 5° to about 20°, or in more detail, with a range (e.g., an optimal range) of about 10° to about 15°.

The polymer may include various suitable materials, such as Teflon, polyethylene (PE), polypropylene (PP), ceramic, polyimide (PI), and/or the like.

According to the electrode plate calendering press as described above, the electrode plate EP may be extruded not by the main roll, but by the pressure belt 330 that is rotated and pressurized by the main roll. In this case, the desired (e.g., the optimal) horizontal and vertical positions of the pulley part 320 and/or the tensioning pulley 370 may be automatically adjusted (e.g., may be automatically set) based on the characteristics of the electrode plate EP to be rolled and the properties of the pressure belt 330 to be in contact with the electrode plate EP.

Accordingly, the contact area of the electrode plate EP and the pressure belt 330 may be increased or maximized without increasing the size of the main roll, thereby increasing the uniformity of the rolling process for the electrode plate EP.

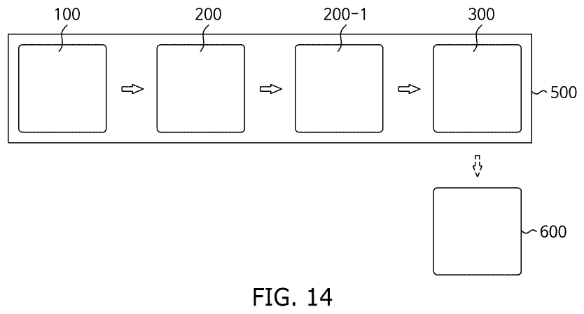

FIG. 14 is a diagram illustrating an electrode plate manufacturing system including the electrode plate calendering press shown in FIG. 1.

Referring to FIG. 14, an electrode plate manufacturing system 500 according to an embodiment of the present disclosure may include a mixer 100 for generating a slurry, a coater 200 for coating the slurry on a substrate to form the electrode plate EP, a drying chamber 200-1 for removing moisture contained in the electrode plate EP, and a press 300 for performing the calendering to the electrode plate EP for compressing the electrode plate EP to a desired thickness (e.g., a predetermined thickness).

The mixer 100 may mix an active material, a binder, and a conductive agent with a solvent to form an active material slurry. A positive electrode active material or a negative electrode active material, a binder, a conductive agent, and various suitable additives may be mixed together with a solvent to form a slurry of the positive electrode active material or a slurry of the negative electrode active material.

The binder may include (e.g., may contain) a polymer additive to stabilize the structure of the electrode, and the conductive agent may include (e.g., may contain) a carbon-based additive to improve an electronic conductivity.

The coater 200 may pass the substrate through a coater head while unwinding the substrate with a suitable tension (e.g., a certain or predetermined tension), and may coat the substrate passing through the coater head by spraying the active material slurry in a desired pattern and thickness (e.g., a predetermined pattern and thickness). Accordingly, an active material having a desired polarity may be coated on the substrate to form the electrode plate EP.

In this case, the electrode plate EP may be formed to have a coated portion where an active material is coated, and an uncoated portion where the active material is not coated. The uncoated portion may have an electrode tab disposed thereon for exchanging external signals with an electrode assembly.

The drying chamber 200-1 may remove solvents and/or moisture within the slurry coated on the electrode plate EP. An amount and temperature of a drying air supplied to the drying chamber 200-1 may be adjusted as needed or desired to effectively dry the electrode plate EP.

The press 300 may apply pressure to the electrode plate EP by positioning the calendering structure 303 between a feed roller 301 (e.g., see FIG. 1) for holding the dried electrode plate EP and a receiving roller 302 for winding up the rolled electrode plate EP.

The press 300 may compress the electrode plate EP to a desired thickness (e.g., a predetermined thickness) by bringing the pressure belt 330 rotating at a desired contact angle (e.g., a set or predetermined contact angle) into contact with the electrode plate EP. The pressure belt 330 may be disposed on at least one of above or below (e.g., underneath) the electrode plate EP.

The press 300 may have the same or substantially the same configuration as any one of the presses 300 described above with reference to FIGS. 1 through 12, and therefore, redundant description thereof may not be repeated.

The electrode plate EP having an improved adhesion of the slurry to the substrate and an increased electrode density due to the rolling process may be transferred to an electrode assembly system 600 to be manufactured into an electrode assembly.

According to the electrode plate manufacturing system described above, the electrode plate may be extruded by pressing the electrode plate or by pressing the electrode plate with grooves formed on the surface of the electrode plate by a rotating pressure belt rather than a main roll. Accordingly, it may be possible to increase or maximize the contact area between the electrode plate EP and the pressure belt 330 without increasing the size of the main roll, and to increase the uniformity of the rolling process for the electrode plate EP.

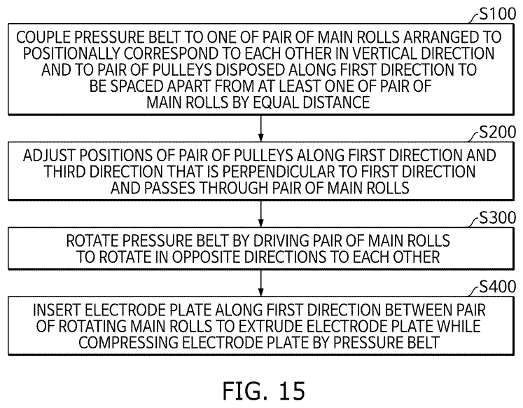

FIG. 15 is a flowchart illustrating a method for performing a calendering to an electrode plate using the press shown in FIG. 1.

Referring to FIG. 15, a pressure belt 330 may be coupled to one of a pair of main rolls 310 disposed to positionally correspond to each other in a vertical direction, and a pair of pulley parts 320 disposed along a first direction I to be spaced apart by an equal distance from at least one of the main rolls 310 (S100).

For example, the pressure belt 330 having predefined properties is coupled to contact at least one of a pair of upper pulleys 321 horizontally spaced apart by an equal distance on both sides of the main roll 310, or a pair of lower pulleys 322 horizontally spaced apart by an equal distance on both sides of the main roll 310.

Subsequently, the positions of the upper pulleys 321 and the positions of the lower pulleys 322 along the first direction I and the third direction III may be adjusted (S200). Reference data including the optimal horizontal positions, vertical positions, and tensions of the upper pulleys 321 and the lower pulleys 322 may be obtained from the reference setting unit 344 based on the properties of the pressure belt 330 and the characteristics of the electrode plate EP. Then, the current positions of the pulleys may be detected to move the positions of the upper pulleys 321 and the lower pulleys 322 to the optimal positions.

In this case, the optimal positions of the upper pulleys 320 and the lower pulleys 320 may be set differently from each other depending on whether the process is the roll rolling process for continuously pressurizing the electrode plate EP without the groove pattern or the pin rolling process for continuously pressurizing the electrode plate EP while forming the groove pattern on the electrode plate EP.

The pair of main rolls 310 may be driven to rotate in opposite directions to each other to thereby rotate the pressure belt 330 (S300). Then, the electrode plate EP may be inserted along the first direction I between the pair of rotating main rolls 310, and may be extruded by pressing the electrode plate EP using the pressure belt 330 or by pressing the electrode plate EP while forming the grooves on the surface of the electrode plate EP using the pressure belt 330 (S400).

In the case of the roll rolling process, the electrode plate EP may be pressed by the pressure belt 330, not by the main rolls 310, and the upper pulleys 321 and lower pulleys 322, which generate the tension on the pressure belt 330, may be controlled to be positioned to increase or maximize the contact area between the electrode plate EP and the pressure belt 330.

In the case of the pin rolling process, the electrode plate EP may be pressed to form the groove G on the surface thereof by the protruding pins 339 arranged on the pressure belt 330, rather than by protrusions arranged on the main roll 310. The upper pulleys 321 and the lower pulleys 322, which generate the tension on the pressure belt 330, may be controlled to be disposed in suitable positions that reduce the contact angle to suppress the fracture of the active material layer provided on the electrode plate.

Accordingly, the contact area between the electrode plate EP and the pressure belt 330 may be increased or maximized, and/or the contact angle between the electrode plate EP and the pressure belt 330 may be reduced, without increasing the sizes of the main rolls 310, thereby increasing the uniformity of the rolling process for the electrode plate EP.

According to some embodiments described above, the electrode plate may be extruded not by the main roll, but by the pressure belt rotated and pressurized by the main roll.

According to some embodiments of the present disclosure, by arranging the protruding pins on the surface of the pressure belt instead of on the main roll, the groove pattern may be formed on the surface of the electrode plate without causing the fracture in the active material layer.

According to some embodiments of the present disclosure, the optimal horizontal and vertical positions of the pulley part and/or the tensioning pulley may be automatically set based on the properties of the electrode plate to be rolled, the characteristics of the pressure belt to be in contact with the electrode plate, and the kind of the rolling process.

According to some embodiments of the present disclosure the contact area between the electrode plate and the pressure belt may be increased or maximized, and the contact angle between the electrode plate and the pressure belt may be reduced, without increasing the size of the main roll, and thus, the uniformity of the rolling process on the electrode plate may be increased and the fracture defects in the active material layer may be reduced.

The electronic or electric devices and/or any other relevant devices or components according to embodiments of the present disclosure described herein (e.g., the contact controller, the horizontal controller, the vertical controller, the tension controller, the reference setting unit, the control processor, and the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A press for performing a calendering to an electrode plate, the press comprising:
a main roll above and below the electrode plate configured to move along a first direction, the main roll being configured to be rotated by a driving force, and having a width along a second direction perpendicular to the first direction;
a pulley part on at least one of above or below the electrode plate, and spaced from the main roll along the first direction;
a pressure belt rotatably coupled to the main roll and the pulley part, and configured to rotate about the second direction by the driving force and press the electrode plate at a contact angle to extrude the electrode plate along the first direction; and
a contact controller configured to control at least one of a contact area or the contact angle between the electrode plate and the pressure belt by controlling a position of the pulley part.

2. The press as claimed in claim 1, wherein the pulley part comprises a pair of upper pulleys above the electrode plate, and horizontally spaced from a single upper main roll of the main roll located adjacent to an upper surface of the electrode plate, and
wherein the pressure belt comprises an upper pressure belt coupled concurrently to the upper main roll and the pair of upper pulleys to form a closed upper circular loop that rotates by the driving force above the electrode plate, and configured to press the upper surface of the electrode plate.

3. The press as claimed in claim 2, wherein the pair of upper pulleys comprises a first upper pulley and a second upper pulley spaced from left and right sides of the upper main roll, respectively, by equal distances as each other along the first direction.

4. The press as claimed in claim 3, further comprising an upper position control rod coupled to each of the first upper pulley and the second upper pulley, and configured to determine a position of each of the first upper pulley and the second upper pulley along the first direction and a third direction to change a shape of the upper pressure belt and adjust the contact area between the upper pressure belt and the electrode plate, and
wherein the third direction is perpendicular to the first direction and the second direction.

5. The press as claimed in claim 4, wherein the pulley part further comprises a pair of lower pulleys below the electrode plate, and horizontally spaced from a single lower main roll of the main roll located adjacent to a lower surface of the electrode plate, and
wherein the pressure belt further comprises a lower pressure belt coupled concurrently to the lower main roll and the pair of lower pulleys to form a closed lower circular loop that rotates by the driving force below the electrode plate, and configured to press the lower surface of the electrode plate.

6. The press as claimed in claim 5, wherein the pair of lower pulleys comprises a first lower pulley and a second lower pulley spaced from left and right sides of the lower main roll, respectively, by equal distances as each other along the first direction.

7. The press as claimed in claim 6, further comprising a lower position control rod coupled to each of the first lower pulley and the second lower pulley, and configured to control a position of each of the first lower pulley and the second lower pulley along the first direction and the third direction to change a shape of the lower belt and adjust the contact area between the lower belt and the electrode plate.

8. The press as claimed in claim 7, wherein the upper position control rod comprises an upper rack gear,
each of the first upper pulley and the second upper pulley comprises an upper pinion gear configured to engage with the upper rack gear,
an upper vertical position of each of the first upper pulley and the second upper pulley along the third direction is determined by moving the upper pinion gear along the third direction,
the lower position control rod comprises a lower rack gear,
each of the first lower pulley and the second lower pulley comprises a lower pinion gear configured to engage with the lower rack gear, and
a lower vertical position of each of the first lower pulley and the second lower pulley along the third direction is determined by moving the lower pinion gear along the third direction.

9. The press as claimed in claim 7, further comprising a horizontal driver connected to at least one of the position control rod or the pulley part, and configured to adjust a separation distance between the pulley part and the main roll along the first direction to control a horizontal position of the pulley part along the first direction.

10. The press as claimed in claim 9, further comprising an upper tension detector connected to one of the pair of upper pulleys and the upper position control rod to detect a tension of the upper pressure belt; and
a lower tension detector connected to one of the pair of lower pulleys and the lower position control rod to detect a tension of the lower pressure belt.

11. The press as claimed in claim 10, wherein each of the upper tension detector and the lower tension detector comprises an elastic body.

12. The press as claimed in claim 7, further comprising:
at least one upper tensioning pulley adjacent to an upper portion of the upper main roll, and configured to adjust an upper tension applied to the upper pressure belt by further tensioning the upper pressure belt upwardly along the third direction; and
at least one lower tensioning pulley adjacent to a lower portion of the lower main roll, and configured to adjust a lower tension applied to the lower pressure belt by further tensioning the lower pressure belt downwardly along the third direction.

13. The press as claimed in claim 12, further comprising:
an upper tension control rod coupled with the upper tensioning pulley, and configured to control a position of the upper tensioning pulley along the third direction; and
a lower tension control rod coupled with the lower tensioning pulley, and configured to control a position of the lower tensioning pulley along the third direction.

14. The press as claimed in claim 1, wherein the contact controller comprises:
a horizontal controller configured to control a horizontal position of the pulley part along the first direction;
a vertical controller configured to control a vertical position of the pulley part along a third direction perpendicular to the first direction and the second direction; and
a tension controller configured to control a tension applied to the pressure belt.

15. The press as claimed in claim 14, wherein the contact controller further comprises:
a reference setting controller configured to provide reference data including the horizontal position, the vertical position, and the tension based on properties of the pressure belt and characteristics of the electrode plate; and
a control processor configured to control the pulley part to move to the horizontal position and the vertical position within a reference tension range.

16. The press as claimed in claim 1, wherein the pressure belt comprises a plurality of protruding pins on an outer surface of the pressure belt, the protruding pins being configured to contact the electrode plate to form a groove pattern on a surface of the electrode plate.

17. The press as claimed in claim 16, wherein the contact angle is in a range from 5° to 20°, and the plurality of protruding pins protrude from a surface of the pressure belt to a height ranging from 5 μm to 50 μm.

18. A system for manufacturing an electrode plate, the system comprising:
a mixer configured to mix an active material, a binder, and a conductive agent with a solvent to form an active material slurry;
a coater configured to coat the active material slurry on a substrate in a pattern to form the electrode plate having a coated portion where the active material slurry is coated and an uncoated portion where the active material slurry is not coated; and
a press configured to compress the electrode plate to a thickness by contacting the electrode plate with a pressure belt configured to rotate at a contact angle and located on at least one of above or below the electrode plate.

19. The system as claimed in claim 18, wherein the press comprises:
a main roll above and below the electrode plate configured to move along a first direction, the main roll being configured to rotate by a driving force, and having a width along a second direction perpendicular to the first direction;
a pulley part on at least one of above or below the electrode plate, and spaced from the main roll along the first direction; and
a contact controller configured to control at least one of a contact area or the contact angle between the electrode plate and the pressure belt by controlling a position of the pulley part.

20. A method of manufacturing an electrode plate, the method comprising:
coupling a pressure belt to one of a pair of main rolls arranged to positionally correspond to each other in a vertical direction and to a pair of pulleys disposed along a first direction to be spaced apart from at least one of the pair of main rolls by an equal distance;
adjusting positions of the pair of pulleys along the first direction and a third direction perpendicular to the first direction and passes through the pair of main rolls;
rotating the pressure belt by driving the pair of main rolls to rotate in opposite directions from each other; and
inserting the electrode plate along the first direction between the pair of rotating main rolls, and extruding the electrode plate by pressing the electrode plate using the pressure belt or by pressing the electrode plate while forming grooves on a surface of the electrode plate using the pressure belt.
